(19) United States
(12) Patent Application Publication
(10) Pub. No.: US 2020/0189486 A1
(43) Pub. Date: Jun. 18, 2020

(54) MOUNTING MEMBER

(71) Applicant: AAUXX KOREA CO., LTD, Seoul (KR)

(72) Inventor: Jin Tae Jang, Seoul (KR)

(21) Appl. No.: 16/476,237

(22) PCT Filed: Jan. 4, 2018
(86) PCT No.: PCT/KR2018/000170

§ 371 Date: Jul. 5, 2019

(30) Foreign Application Priority Data
Jan. 5, 2017 (KR) 20-2017-0000101

(51) Int. Cl. B60R 11/02; B62J 50/21; H04B 1/3877

(52) U.S. Cl. CPC B60R 11/0241; B60R 2011/0063; H04B 1/3877; B62J 50/225

(57) ABSTRACT

A mounting member for mounting a mobile device and a mobile device accessory of being fixed to one face of the mobile device and having a ring on an object is disclosed. The mounting member includes a body having a plate shape, a ring insertion hole penetrating the body and extending along one direction of the body, the ring inserting hole being configured for the ring to be inserted downwardly thereinto, and a fixing hole formed on a lower surface portion of the body to cross the ring insertion hole, the fixing hole being configured to fix the ring inserted in the ring insertion hole and rotated to the body.

### BACKGROUND OF THE INVENTION

### 1. Field of the Invention

Example embodiments of the present invention relate to a mounting member. More particularly, example embodiments of the present invention relate to a mounting member for mounting a mobile device and a mobile device accessory including a ring to be fixed to a face of the mobile device to an object.

### 2. Description of the Related Art

Recently, a mobile device such as a portable media player (PMP) has come into wide use. Users have utilized various accessories in order to carry the mobile device easily. For example, a strap-type accessory which can bind one side of the mobile device helps the users to carry the mobile device conveniently.

The mobile device generally operates while grasping the mobile device with hands , the mobile device may work occasionally with being positioned on a particular position such as a vehicle, a bicycle, etc.

According to the prior art, a fixing part may be required for fixing the mobile device by using a clamping structure or a spring elastic structure.

The disadvantage of the fixing part is that a size of the clamping structure must increase as a size of the mobile device increases. The fixing part may be very obstructive to a view of a driver while driving the vehicle, and even when not in use, the clamping structure may occupy a wide area of a dashboard of the vehicle.

Further, the fixing part included in the clamping structure can grip the mobile device using an elastic force of a spring. Thus, the clamping structure is very vulnerable to external impacts such that there is a high possibility that a breakage of the spring occurs due to a shock while driving the vehicle or the bicycle on an uneven road. As a result, the spring may leave out of a damper of holding the mobile device due to elastic characteristics.

### SUMMARY OF THE INVENTION

Example embodiments of the present invention provide a mounting member for mounting a mobile device on an object stably.

According to one aspect of the present invention, there is provided a mounting member for mounting a mobile device and a mobile device accessory of being fixed to one face of the mobile device and having a ring on an object, the mounting member includes a body having a plate shape, a ring insertion hole penetrating the body and extending along one direction of the body, the ring inserting hole being configured for the ring to be inserted downwardly thereinto and a fixing hole formed on a lower surface portion of the body to cross the ring insertion hole, the fixing hole being configured to fix the ring inserted in the ring insertion hole and rotated to the body.

In an example embodiment, a sloped portion may be formed between the ring insertion hole and the fixing hole and being inclinded toward an intersection point of the ring insertion hole and the fixing hole such that the ring inserted into the ring insertion hole smoothly rotates.

In an example embodiment, the body may include a receiving groove formed at an upper surface thereof, the receiving groove being configured to receive an adhersive plate for adhering the ring to the mobile device.

Here, the mobile device accessory includes a connection block rotably fixed to the adhesive plate, the connecting block connecting the ring to the adhesive plate, and the mounting member may further include a block insertion hole formed at a intersection point of the ring insertion hole and the fixing hole and penetrating through the body, the block insertion hole being configured for the connecting block to be inserted thereinto.

In an example embodiment, the mounting member may further include a fixing part disposed on a lower surface of the body, the fixing part fixing the body to the object.

Here, the fixing part may include a clamp having a plurality of penetration holes extending along a horizontal direction such that the object is fixed along the penetration holes.

Alternatively, the fixing part may include a screw hole being configured to be fastened to the object.

Alternatively, the fixing part may include an adhesive part being configured to be adhered to the object.

According to example embodiments, the mounting member may fix the ring rotatably fixed to one surface of the mobile device to the body by inserting the ring into the ring insertion hole and then rotating the ring. Therefore, the mobile device and the mobile device accessory having the ring may be easily and stably fixed to the mounting member.

Further, the mounting member may fix the ring which is rotated in a state of being inserted into the ring insertion hole by using the fixing hole. Therefore, it is possible to prevent the ring from rotating toward the ring insertion hole by vibration or the like, and to prevent the ring from being detached from the body.

The mounting member may include receiving groove for accommodating an adhesive plate for adhering the ring to the mobile device. Here, the receiving groove may be formed in the upper surface of the body. Therefore, since the adhesive plate may be brought into close contact with the upper surface of the body, it is possible to prevent the adhesive plate from slipping with respect to the body. Accordingly, the mobile device and the mobile device accessory having the ring may be more stably fixed to the mounting member.

### BRIEF DESCRIPTION OF THE DRAWINGS

The above and other features and advantages of the present invention will become more apparent by describing in detailed example embodiments thereof with reference to the accompanying drawings, in which:

FIG. 1 is a perspective view illustrating a mounting member in accordance with an example embodiment of the present invention;

FIG. 2 is a bottom view illustrating the mounting member in FIG. 1; and

FIGS. 3 to 5 are perspective views illustrating steps of fixing the mobile device and the accessory to the mounting member.

### DESCRIPTION OF THE EMBODIMENTS

Hereinafter, mounting members are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element discussed below could be termed a second element without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

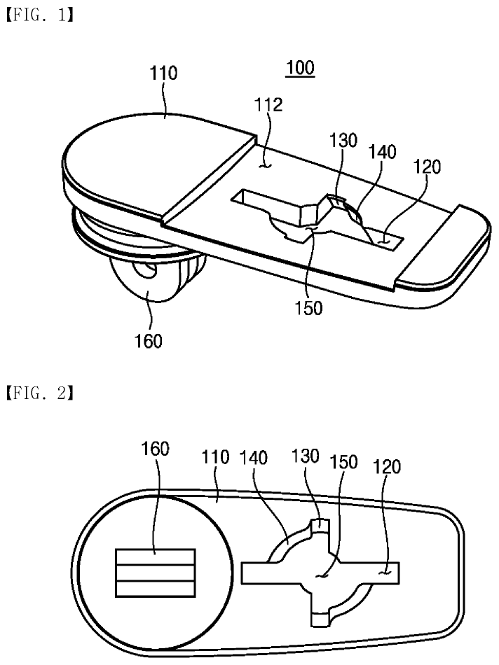

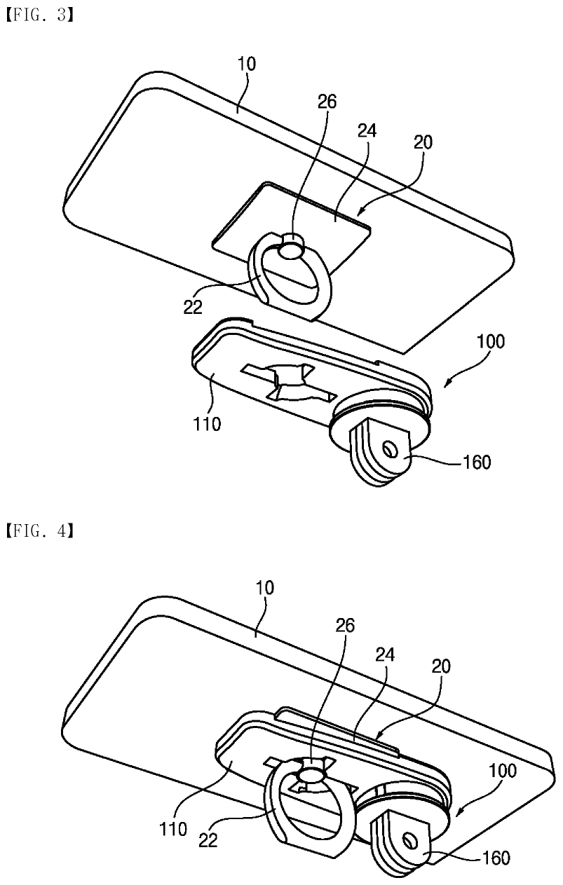

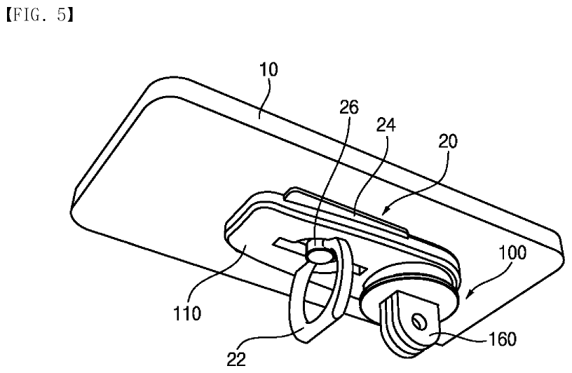

FIG. 1 is a perspective view illustrating a mounting member in accordance with an example embodiment of the present invention. FIG. 2 is a bottom view illustrating the mounting member in FIG. 1. FIGS. 3 to 5 are perspective views illustrating steps of fixing the mobile device and the accessory to the mounting member.

Referring to FIGS. 1 to 5, a mounting member 100 in accordance with an example embodiment includes a body 110, a ring insertion hole 120, a fixing hole 130, a sloped portion 140, a block receiving groove 150 and a fixing part 160.

The mounting member 100 may be used for mounting a mobile device 10 and a mobile device accessory 20 having a ring 25 and being secured to one side of the mobile device 10 to an object.

Examples of the mobile device 10 include a mobile phone, a PMP, an MP3 player, an electronic dictionary, a tablet PC, and the like.

Examples of the object include a cradle, a plate, a dashboard for a vehicle, a selfie stick, handle bars of a bicycle and a motorcycle, and the like.

The mobile device accessory 20 may include a ring 22 being configured to be rotably fixed to one surface of the mobile device 10, an adhesive plate 24 for adhering the ring 22 to the mobile device 10, and a connecting block rotably fixed to the adhesive plate 24 for connecting the ring 22 with the adhesive plate 24. An example of the mobile device accessory 20 is described in detail in the specification of the Korean Patent Application No. 10-2013-0040554 filed on Mar. 12, 2013, the details of which will be omitted.

Further, the mobile device accessory 20 may be modified on the condition that the ring 22 may be rotably fixed to the one surface of the mobile device 10.

The body 110 may have a plate shape. For example, the body 110 has a rectangular parallelepiped shape. A lower surface portion of the body 110 may be fixed to an upper surface of the object.

The ring insertion hole 120 penetrates through the body 110. The ring insertion hole 120 may extend in an extending direction of the body 110.

The ring insertion hole 120 may have a length larger than that of the ring 22. Therefore, the ring 22 may be easily inserted into the ring insertion hole 120. The ring 22 may be downwardly inserted into the ring inserting hole 120.

The ring 22 may be fixed to the body 110 by rotating the ring 22, while the ring 22 is inserted into the ring insertion hole 120. Therefore, the mobile device 10 and the mobile device accessory 20 including the ring 22 may be easily and stably fixed to the mounting member 100.

The body 110 may have a receiving groove 112. The receiving groove 112 is formed on an upper surface of the body 110. The ring insertion hole 120 may be formed at a position where the receiving groove 112 is formed in the body 110. The adhesive plate 24 may be received in the receiving groove 112 while the ring 22 is inserted into the ring insertion hole 120. Therefore, the adhesive plate 24 makes close contact with the body 110, and the adhesive plate 24 may be prevented from slipping with respect to the body 110. As a result, the mobile device 10 and the mobile device accessory 20 having the ring 22 may be more stably fixed to the mounting member 100.

The fixing hole 130 is formed on the lower surface of the body 110. The fixing hole 130 extends to cross the ring insertion hole 120. The extending directions of the ring insertion hole 120 and the fixing hole 130 may be crossed to each other that the extending directions are crossed to have various angles. For example, the extension directions of the ring insertion hole 120 and the fixing hole 130 is orthogonal to each other. The fixing hole 130 may fix the ring 22 inserted in the ring insertion hole 120 to the body 110. Therefore, the ring 22 may be prevented from rotating toward the ring insertion hole 120 by vibration or the like. Therefore, the ring 22 may be prevented from being detached from the body 110.

The inclined portion 140 is formed between the ring insertion hole 120 and the fixing hole 130 and is formed on the lower surface of the body 110. The inclined portion 140 is inclined toward an intersection point of the ring insertion hole 120 and the fixing hole 130. The ring 22 may be easily rotated between the ring insertion hole 120 and the fixing hole 130 along the inclined portion 140 while the ring 22 is accommodated in the ring insertion hole 120. Therefore, the ring 22 received in the ring insertion hole 120 may be easily rotated owing to the inclined surface 140.

In case that the inclined portion is not provided, a portion of the body 110, which is positioned between the ring insertion hole 120 and the fixing hole 130, may act as a latching jaw when the ring 22 rotates while being accommodated in the ring insertion hole 120. Therefore, the ring 22 may be difficult to rotate due to the portion o the body 110.

The block insertion hole 150 is formed through the body 110 so as to penetrate vertically through the intersection point of the ring insertion hole 120 and the fixing hole 130. The connection block 26 can be inserted into the block insertion hole 150. Therefore, since the connecting block 26 may be received into the block insertion hole 150, the ring 22 may be easily inserted into the ring insertion hole 120.

The fixing part 160 is provided on a lower surface of the body 110. The fixing part may fix the body 110 to the object.

For example, the fixing part 160 includes a clamp. The clamp may have a plurality of penetration holes formed in the horizontal direction. Thus, the object having a plurality of protrursion portions which are configured to be inserted into the penetrations holes, may be connected with the fixing part 160.

In another example, the fixing part 160 may include a screw hole that may be fastened to the object. The object may be a selfie stick, a tripod, or the like, and the object may include a fastening portion with a threaded protrusion to be coupled with the screw hole.

In another example, the fixing part 160 may include an adhesive part to be adhered to the object. Examples of the adhesive part include an adhesive tape or a magnetic substance using magnetic properties.

Meanwhile, the adhesive part may not be directly provided on the lower surface of the body 110, and the adhesive part may be provided on a base member positioned on the lower surfaces of the body 110. The base member may be screwed to the lower surface of the body 110.

In another example, the fixing part 160 may be an adsorption plate for adsorbing the object with a vacuum force.

According to some embodiment, the mounting member may stably secure the mobile device and the mobile device accessory to prevent the mobile device and the accessory accessory from being detached from the mounting member. Therefore, it is possible to prevent the mobile device and the mobile device accessory from being damaged or broken due to the detachment.

The foregoing is illustrative of the present invention and is not to be construed as limiting thereof Although a few exemplary embodiments of this invention have been described, those skilled in the art will readily appreciate that many modifications are possible in the exemplary embodiments without materially departing from the novel teachings and advantages of the present invention.

What is claimed is:

1. A mounting member for mounting a mobile device and a mobile device accessory being fixed to one face of the mobile device and having a ring on an object, the mounting member comprising:
a body having a plate shape;
a ring insertion hole penetrating the body and extending along one direction of the body, the ring inserting hole being configured for the ring to be inserted downwardly thereinto; and
a fixing hole formed on a lower surface portion of the body to cross the ring insertion hole, the fixing hole being configured to fix the ring inserted in the ring insertion hole and rotated to the body.

2. The mounting member of claim 1, further comprising a sloped portion being formed between the ring insertion hole and the fixing hole and being inclinded toward an intersection point of the ring insertion hole and the fixing hole such that the ring inserted into the ring insertion hole smoothly rotates.

3. The mounting member of claim 1, wherein the body includes a receiving groove formed at an upper surface thereof, the receiving groove being configured to receive an adhersive plate for adhering the ring to the mobile device.

4. The mounting member of claim 3, wherein the mobile device accessory includes a connection block rotatably fixed to the adhesive plate, the connecting block connecting the ring to the adhesive plate, and
further comprising a block insertion hole formed at a intersection point of the ring insertion hole and the fixing hole and penetrating through the body, the block insertion hole being configured for the connecting block to be inserted thereinto.

5. The mounting member of claim 1, further comprising a fixing part disposed on a lower surface of the body, the fixing part fixing the body to the object.

6. The mounting member of claim 5, wherein the fixing part includes a clamp having a plurality of penetration holes extending along a horizontal direction such that the object is fixed along the penetration holes.

7. The mounting member of claim 5, wherein the fixing part includes a screw hole being configured to be fastened to the object.

8. The mounting member of claim 5, wherein the fixing part includes an adhesive part being configured to be adhered to the object.
